(19) United States
(12) Patent Application Publication
(10) Pub. No.: US 2025/0303894 A1
(43) Pub. Date: Oct. 2, 2025

(54) CHARGING SYSTEM

(71) Applicant: HONDA MOTOR CO., LTD., Tokyo (JP)

(72) Inventors: Masataka OHASHI, Saitama (JP); Yasushi OGIHARA, Saitama (JP); Yasuo YAMADA, Saitama (JP); Harumi TAKEDOMI, Saitama (JP); Yoshio KOJIMA, Saitama (JP)

(73) Assignee: HONDA MOTOR CO., LTD., Tokyo (JP)

(21) Appl. No.: 19/063,335

(22) Filed: Feb. 26, 2025

(30) Foreign Application Priority Data
Mar. 28, 2024 (JP) 2024-052883

(51) Int. Cl. B60L 53/24; B60L 50/51; B60L 50/60

(52) U.S. Cl. CPC B60L 53/24; B60L 50/51; B60L 50/60; B60L 2210/10; B60L 2210/40

(57) ABSTRACT

A charging system has a battery, an auxiliary device driven by electric power supplied from the battery when the battery supplies the electric power, a DC voltage conversion unit which converts a DC voltage at a charging equipment side to an auxiliary device side voltage different from a battery voltage and supplies the auxiliary device side voltage to the auxiliary device, and a control unit which controls the DC voltage conversion unit. The DC voltage conversion unit includes coils of a plurality of phases, and conversion units provided for every phases. The control unit includes a phase number selection unit which determines the auxiliary device side voltage based on operation required information of the auxiliary device, determines the number of phases to be driven based on the auxiliary device side voltage, and drives the determined number of phases to supply electric power to the auxiliary device.

### CROSS-REFERENCE TO RELATED APPLICATIONS

This application is based on and claims priority under 35 USC 119 from Japanese Patent Application No. 2024-052883 filed on Mar. 28, 2024, the entire content of which is incorporated herein by reference.

### TECHNICAL FIELD

The present disclosure relates to a charging system.

### BACKGROUND ART

In recent years, researches and developments have been conducted on charging and power feeding in a vehicle mounted with a secondary battery that contributes to an increase in energy efficiency in order to allow more users to access affordable, reliable, sustainable, and advanced energy.

In relation to charging and power supply in a vehicle including a secondary battery, there are two types of charging equipment such as charging stations: a 400 V class with an upper limit voltage of 500 V, and an 800 V class with an upper limit voltage of 1000 V. When a vehicle is compatible with only the charging equipment of 400 V class, the vehicle cannot enjoy quick charging performance of the charging equipment of 800 V class.

In a case where the vehicle is both compatible with the charging equipment of 400V class and 800 V class, generally, a voltage is boosted to 800 V by a voltage converter when charging with the charging equipment of 400 V class, or the voltage is stepped down to 400 V with the voltage converter when charging with the charging equipment of 800 V class. However, using such a voltage converter for charging deteriorates efficiency during charging.

In this regard, there is known a vehicle in which a connection system of a battery module is switched so as to be chargeable with both the charging equipment of 400 V class and the charging equipment of 800 V class without using any voltage converter for charging (for example, US2023/0299695A).

An auxiliary device used in a vehicle also needs to be driven by electric power supplied from charging equipment during charging. Therefore, it has been proposed to provide a DCDC converter in a vehicle, convert electric power supplied from charging equipment by the DCDC converter, and supply the converted electric power to the auxiliary device (for example, US2023/0150378A).

When electric power supplied from charging equipment is converted by a DCDC converter, it is desirable to efficiently convert a voltage and supply the converted voltage to an auxiliary device.

### SUMMARY OF INVENTION

The present disclosure provides a charging system capable of suppling electric power provided from a charging equipment to an auxiliary device with high efficiency.

A first aspect of the present disclosure relates to a charging system of a vehicle, the charging system including:
a battery;
an auxiliary device configured to be driven by electric power supplied from the battery when the battery supplies the electric power, in which the power supply from the battery to the auxiliary device is cut off when the battery is charged;
a DC voltage conversion unit configured to convert a DC voltage at a charging equipment side to an auxiliary device side voltage different from a battery voltage, and supply the auxiliary device side voltage to the auxiliary device; and
a control unit configured to control the DC voltage conversion unit,
in which the DC voltage conversion unit includes coils of a plurality of phases, and conversion units provided for every phases of the plurality of phases,
the control unit includes a phase number selection unit configured to select a number of phases to be driven among the plurality of phases, and
the phase number selection unit is configured to:
   determine the auxiliary device side voltage based on operation required information of the auxiliary device,
   determine the number of phases to be driven based on the auxiliary device side voltage; and
   drive the determined number of phases to supply electric power to the auxiliary device.

A second aspect of the present disclosure relates to a charging system including:
a battery;
a three-phase motor including coils of three phases driven by electric power supplied from the battery;
an inverter including conversion units for every phases of the three phases, and configured to convert DC electric power of the battery to AC electric power of the three phases;
an auxiliary device configured to be driven by electric power supplied from the battery when the battery supplies the electric power, in which the power supply from the battery to the auxiliary device is cut off when the battery is charged;
a DC voltage conversion unit including the coils of the three phases of the three-phase motor, and the conversion units provided for every phases of the three phases of the inverter; and
a control unit configured to control charging of the battery,
in which a charging terminal is connected between the coil of any one phase of the coils of the three phases of the three-phase motor and the conversion unit of the one phase of the inverter, and
when charging the battery, based on operation required information of the auxiliary device, the control unit selects a two-phase booster mode and a one-phase booster mode to supply electric power to the auxiliary device, in which
   in the two-phase booster mode, other two phases of the coils of the three phases of the three-phase motor are driven to boost a charging voltage, and
   in the one-phase booster mode, one of the other two phases of the coils of the three phases of the three-phase motor is driven to boost the charging voltage.

A third aspect of the present disclosure relates to a charging system including:
a battery;
a three-phase motor including coils of three phases driven by electric power supplied from the battery;
an inverter including conversion units for every phases of the three phases, and configured to convert DC electric power of the battery to AC electric power of the three phases;
an auxiliary device configured to be driven by electric power supplied from the battery when the battery supplies the electric power, in which the power supply from the battery to the auxiliary device is cut off when the battery is charged;
a DC voltage conversion unit including the coils of the three phases of the three-phase motor, and the conversion units provided for every phases of the three phases of the inverter; and
a control unit configured to control charging of the battery,
in which a charging terminal is connected to a neutral point of the coils of the three phases of the three-phase motor, and
when charging the battery, based on operation required information of the auxiliary device, the control unit selects a three-phase booster mode, a two-phase booster mode, and a one-phase booster mode to supply electric power to the auxiliary device, in which
   in the three-phase booster mode, the coils of the three phases of the three-phase motor are driven to boost a charging voltage,
   in the two-phase booster mode, any two phases of the coils of the three phases of the three-phase motor are driven to boost the charging voltage, and
   in the one-phase booster mode, any one phase of the coils of the three phases of the three-phase motor is driven to boost the charging voltage.

According to the aspects of the present disclosure, the electric power provided from the charging equipment can be supplied to the auxiliary device with high efficiency.

### BRIEF DESCRIPTION OF DRAWINGS

Exemplary embodiment(s) of the present invention will be described in detail based on the following figures, wherein:

FIG. 1 is a diagram showing a configuration of a charging system 1 according to a first embodiment;

FIG. 2 is a diagram showing a first voltage state (800 V start-up) of a battery 2;

FIG. 3 is a diagram showing a second voltage state (400 V start-up) of the battery 2;

FIG. 4 is a diagram showing a flow of a current during traveling of an electric vehicle including the charging system 1 according to the first embodiment;

FIG. 5 is a diagram showing a flow of a current during charging at a first voltage (800 V) of the electric vehicle including the charging system 1 according to the first embodiment;

FIG. 6 is a diagram showing a flow of a current during charging at a second voltage (400 V) of the electric vehicle including the charging system 1 according to the first embodiment;

FIG. 7 is a schematic diagram showing a schematic configuration of the charging system 1 according to the first embodiment;

FIG. 8 is a diagram showing a flow of a current at the time of two-phase boosting during charging at the second voltage (400 V) in the charging system 1 according to the first embodiment;

FIG. 9 is a diagram showing a flow of a current at the time of one-phase boosting during charging at the second voltage (400 V) in the charging system 1 according to the first embodiment;

FIG. 10 is a flowchart showing a boosting control scheme 1 according to the first embodiment;

FIGS. 11A to 11C are diagrams showing a method for determining a secondary voltage in the boosting control scheme 1;

FIG. 12 is a diagram showing a method for determining a boosting phase in the boosting control scheme 1;

FIG. 13 is a flowchart showing a boosting control scheme 2 according to the first embodiment;

FIG. 14 is a diagram showing a method for determining a secondary voltage in the boosting control scheme 2;

FIG. 15 is a flowchart showing a boosting control scheme 3 according to the first embodiment;

FIG. 16 is a diagram showing a method for determining a secondary voltage and a boosting phase in the boosting control scheme 3;

FIG. 17 is a schematic diagram showing a schematic configuration of the charging system 1 according to a second embodiment;

FIG. 18 is a diagram showing a flow of a current at the time of three-phase boosting during charging at the second voltage (400 V) in the charging system 1 according to the second embodiment;

FIG. 19 is a diagram showing a flow of a current at the time of two-phase boosting during charging at the second voltage (400 V) in the charging system 1 according to the second embodiment;

FIG. 20 is a diagram showing a flow of a current at the time of one-phase boosting during charging at the second voltage (400 V) in the charging system 1 according to the second embodiment; and

FIG. 21 is a diagram showing a method for determining a boosting phase in the second embodiment.

### DESCRIPTION OF EMBODIMENTS

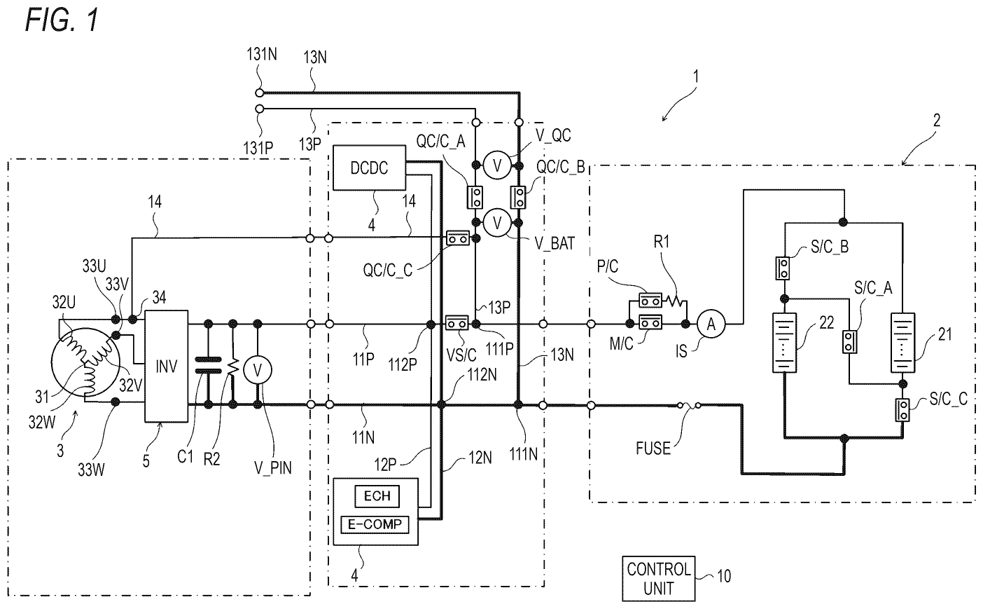

Hereinafter, embodiments of the present disclosure will be described with reference to the drawings. First, a first embodiment of the present disclosure will be described with reference to FIGS. 1 to 16.

### First Embodiment

A charging system 1 according to the first embodiment shown in FIG. 1 is mounted on an electric vehicle such as an electric automobile. The electric vehicle including the charging system 1 is compatible with charging equipment of 400 V class and 800 V class. The electric vehicle can not only quickly charge a battery 2 at charging voltages of 400 V and 800 V but also efficiently drive a three-phase motor 3 and an auxiliary device 4 at a base voltage of 800 V. It should be noted that the auxiliary device 4 can be driven at a voltage other than 800 V.

Specifically, as shown in FIG. 1, the charging system 1 includes the battery 2, the three-phase motor 3, the auxiliary device 4, an inverter 5 (INV), electric power supply circuits 11P and 11N, auxiliary device drive circuits 12P and 12N, DC power supply circuits 13P and 13N, a branch circuit 14, and a control unit 10.

As shown in FIGS. 1 to 3, the battery 2 includes a first power storage unit 21, a second power storage unit 22, first to fifth contactors M/C, S/C_A, S/C_B, S/C_C, P/C, a first resistor R1, a current sensor IS, and a current breaker FUSE.

The first power storage unit 21 and the second power storage unit 22 are battery modules which can perform charging and power supply of 400 V.

The first contactor M/C is provided on a positive electrode side end of the battery 2 and functions as a main switch which turns on and off connection to the outside (electric power supply circuit 11P) of the battery 2.

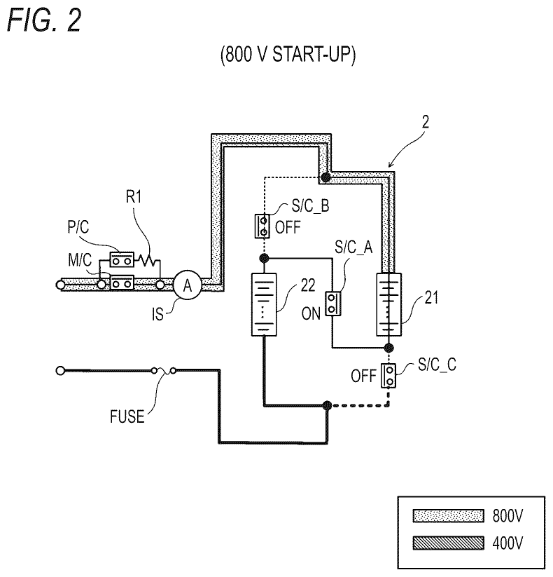

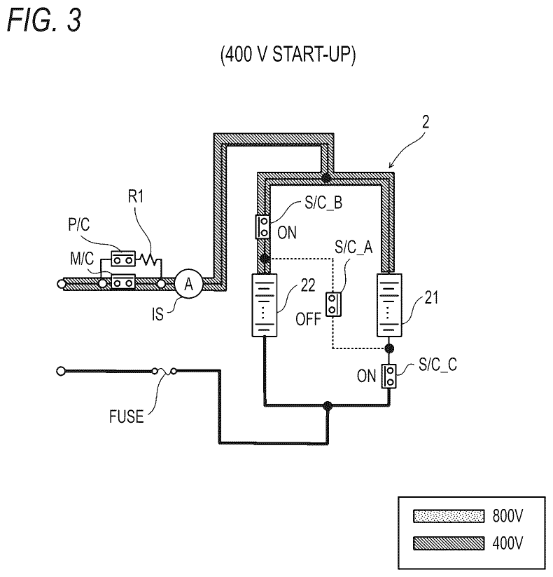

The second to fourth contactors S/C_A, S/C_B, and S/C_C switch a connection state between the first power storage unit 21 and the second power storage unit 22. For example, as shown in FIG. 2, when the second contactor S/C_A is turned on and the third contactor S/C_B and the fourth contactor S/C_C are turned off, the battery 2 is in a first voltage state (800 V start-up) in which the first power storage unit 21 and the second power storage unit 22 are connected in series, so that the battery 2 can be charged and supply power at 800 V. As shown in FIG. 3, when the second contactor S/C_A is turned off, and the third contactor S/C_B and the fourth contactor S/C_C are turned on, the battery 2 is in a second voltage state (400 V start-up) in which the first power storage unit 21 and the second power storage unit 22 are connected in parallel, so that the battery 2 can be charged and supply power at 400 V. Note that the term start-up refers to a concept including driving during traveling of an electric vehicle including the charging system 1 and charging during parking of the electric vehicle.

The fifth contactor P/C and the first resistor R1 are arranged in series with each other and in parallel with the first contactor M/C. In the first voltage state and the second voltage state, the fifth contactor P/C is turned on before the first contactor M/C is turned on, thereby protecting the first contactor M/C from an excessive inrush current.

The current sensor IS is disposed between the first contactor M/C and the power storage units 21 and 22 to measure a current.

The current breaker FUSE is provided on a negative electrode side end of the battery 2 and cuts off the connection to the outside (the electric power supply circuit 11N) of the battery 2 when an abnormality occurs. In the charging system 1 according to the present embodiment, the current breaker FUSE is implemented by a pyro-fuse which can intentionally cut off a current according to an electrical signal. When an abnormality (for example, vehicle collision or a short circuit in the battery 2) occurs, the current breaker FUSE is operated to cut off, and all the contactors in the battery 2 are turned off (opened).

The three-phase motor 3 includes coils 32U, 32V, and 32W of three phases, one end side of each of which is connected to a neutral point 31, and is rotationally driven by electric power provided from the battery 2 via the inverter 5. The three-phase motor 3 in the present embodiment includes a U-phase terminal 33U, a V-phase terminal 33V, and a W-phase terminal 33W connected to the other end side of each of the coils 32U, 32V, and 32W, respectively. The U-phase terminal 33U, the V-phase terminal 33V, and the W-phase terminal 33W are connected to the inverter 5. The other end side of a coil of any one phase among the coils 32U, 32V, and 32W is connected to the branch circuit 14 at a connection portion 34. In the present embodiment, the U-phase coil 32U among the coils 32U, 32V, and 32W of the three phases is connected to the branch circuit 14 at the connection portion 34 positioned between the U-phase terminal 33U and the inverter 5.

The inverter 5 converts DC electric power provided from the battery 2 to three-phase AC electric power by switching of a plurality of switching elements, so as to rotationally drive the three-phase motor 3. As will be described in more detail later, when a DC current (400 V) is supplied from the branch circuit 14 to the connection portion 34, the inverter 5 can function as a booster circuit (DC voltage conversion unit) to boost the DC current using the coil connected to the branch circuit 14 and the coil of another one phase or another two phases, by the switching of the plurality of switching elements.

The auxiliary device 4 is an in-vehicle device that can be driven by DC electric power from the battery 2 and an external power supply, and includes, for example, an electric compressor E-COMP for an air conditioner (A/C), an electric heater ECH, and a converter DCDC for an auxiliary device. The electric compressor E-COMP and the electric heater ECH are high-voltage drive in-vehicle devices, and the converter DCDC for an auxiliary device steps down DC electric power from the battery 2 and an external power supply to drive low-voltage drive in-vehicle devices. The auxiliary device 4 is connected to the battery 2 via the auxiliary device drive circuits 12P and 12N, a sixth contactor VS/C, and the electric power supply circuits 11P and 11N. The auxiliary device 4 of the present embodiment is operated at a base voltage of 800 V while the vehicle is traveling. On the other hand, the auxiliary device 4 is capable of operating even when the voltage is not 800 V, and is configured to operate by being boosted to an efficient drive voltage during charging at 400 V described later.

The electric power supply circuits 11P and 11N are configured as a positive and negative pair and connect the battery 2 and the inverter 5 (three-phase motor 3). The electric power supply circuits 11P and 11N are provided with connection portions 111P and 111N connected to the DC power supply circuits 13P and 13N and are provided with connection portions 112P and 112N connected to the auxiliary device drive circuits 12P and 12N (auxiliary device 4) on a side closer to the inverter 5 than the connection portions 111P and 111N. The electric power supply circuit 11P at the positive electrode side is provided with the sixth contactor VS/C which turns on and off the circuit between the connection portion 112P connected to the auxiliary device drive circuit 12P and the connection portion 111P connected to the DC power supply circuit 13P. A first voltage sensor V_PIN, a first smoothing capacitor C1, and a second resistor R2 are provided on the inverter 5 side of the electric power supply circuits 11P and 11N. The first voltage sensor V_PIN, the first smoothing capacitor C1, and the second resistor R2 are provided on a circuit that connects the electric power supply circuit 11P at the positive side and the electric power supply circuit 11N at the negative side. Note that the second resistor R2 is provided to discharge the first smoothing capacitor C1 when the circuit is cut off.

The DC power supply circuits 13P and 13N are configured as a positive and negative pair and include one end provided with charging terminals 131P and 131N to which an external power supply such as charging equipment can be connected and the other end connected to the electric power supply circuits 11P and 11N via the connection portions 111P and 111N. The DC power supply circuits 13P and 13N are provided with a seventh contactor QC/C_A and an eighth contactor QC/C_B for turning on and off the circuits, respectively. A second voltage sensor V_BAT is provided at a position closer to the connection portions 111P and 111N than the seventh contactor QC/C_A and the eighth contactor QC/C_B. A third voltage sensor V_QC is provided at a position closer to the charging terminals 131P and 131N than the seventh contactor QC/C_A and the eighth contactor QC/C_B.

The branch circuit 14 is branched, in the DC power supply circuit 13P at the positive side, at a position closer to the connection portion 111P than the eighth contactor QC/C_A and the second voltage sensor V_BAT, and is connected to one of the coils of the three-phase motor 3 via the connection portion 34. An intermediate portion of the branch circuit 14 is provided with a ninth contactor QC/C_C for turning on/off the circuit.

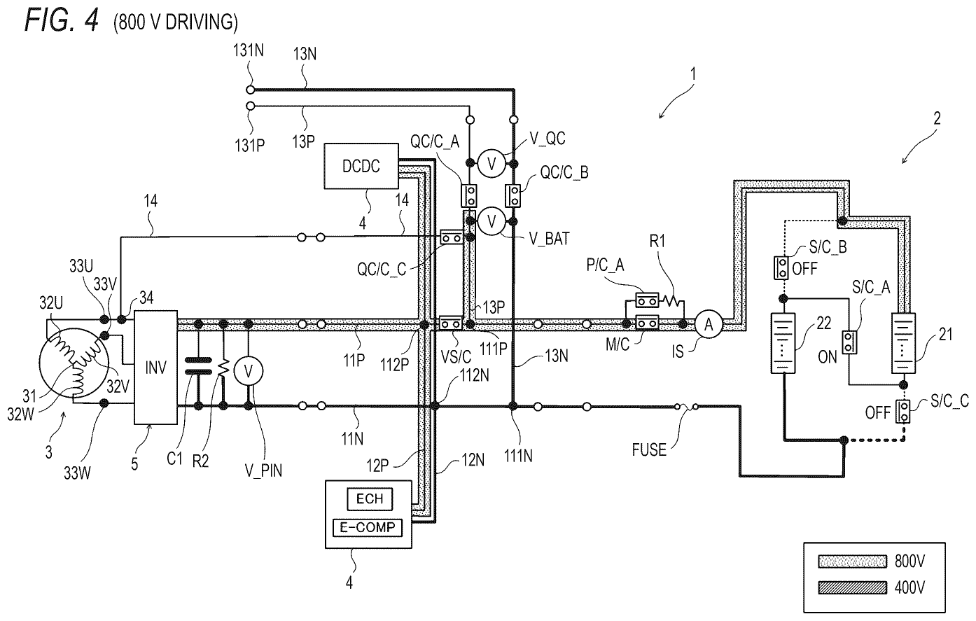

The control unit 10 is, for example, a vehicle ECU and controls driving and charging of the charging system 1. More specifically, the control unit 10 performs an ON/OFF control of the contactors M/C, S/C_A, S/C_B, S/C_C, P/C, VS/C, QC/C_A, QC/C_B, and QC/C_C, detection of welding of these contactors, control of the inverter 5, and the like. Next, an operation of the charging system 1 will be described with reference to FIGS. 4 to 6.

FIG. 4 is a diagram showing a flow of a current during traveling (800 V driving) of the electric vehicle including the charging system 1 according to a first embodiment.

As described above, the electric vehicle including the charging system 1 drives the three-phase motor 3 and the auxiliary device 4 at the base voltage of 800 V, and the battery 2 is controlled to an 800 V start-up state shown in FIG. 2 during the traveling. The control unit 10 turns on the first contactor M/C and the sixth contactor VS/C, and turns off the seventh contactor QC/C_A, the eighth contactor QC/C_B, and the ninth contactor QC/C_C.

In this mode, a voltage of 800 V is supplied from the battery 2 to the three-phase motor 3 via the inverter 5, enabling the electric vehicle to travel. In this case, the auxiliary device 4 is driven by a voltage of 800 V supplied from the battery 2 via the electric power supply circuits 11P and 11N and the auxiliary device drive circuits 12P and 12N.

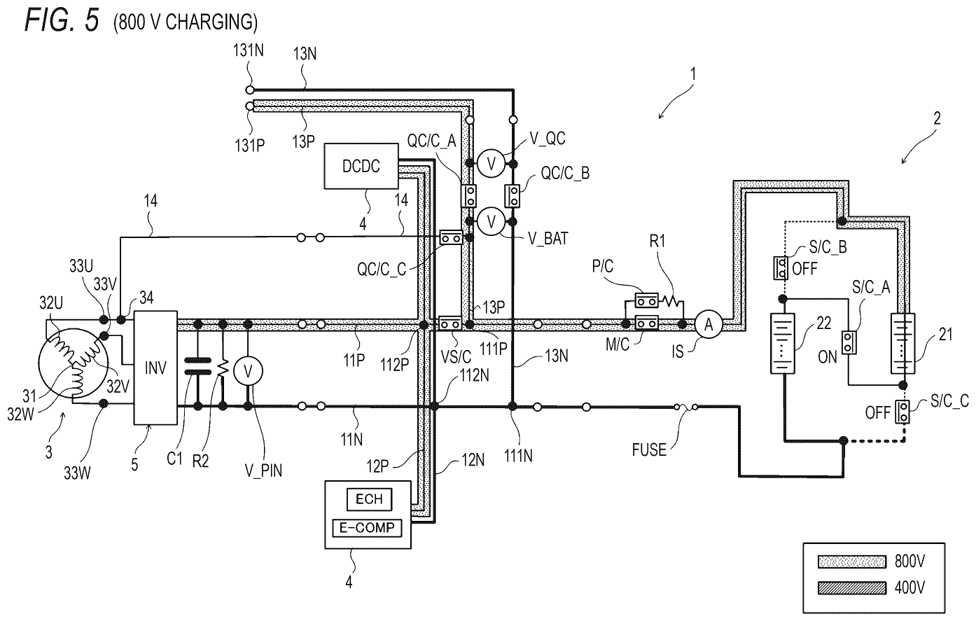

FIG. 5 is a diagram showing a flow of a current during charging at the first voltage (800 V charging) of the electric vehicle including the charging system 1 according to the first embodiment.

When charging with the charging equipment of 800 V class, the battery 2 is controlled to the 800 V start-up state shown in FIG. 2. The control unit 10 turns on the first contactor M/C, the seventh contactor QC/C_A, the eighth contactor QC/C_B, and the sixth contactor VS/C, and turns off the ninth contactor QC/C_C. Accordingly, a voltage of 800 V is supplied from the charging terminals 131P and 131N to the battery 2, and a voltage of 800 V is supplied to the auxiliary device 4 via the electric power supply circuit 11P and the auxiliary device drive circuit 12P.

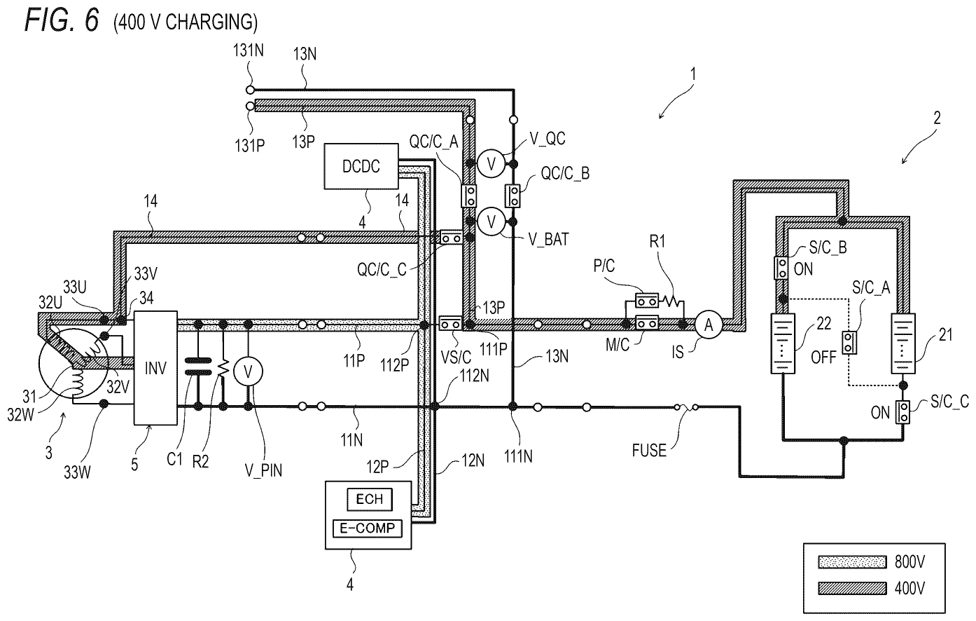

FIG. 6 is a diagram showing a flow of a current during charging at a second voltage (400 V charging) of the electric vehicle including the charging system 1 according to the first embodiment.

When charging with the charging equipment of 400 V class, the battery 2 is controlled to a 400 V start-up state shown in FIG. 3. The control unit 10 turns on the first contactor M/C, the seventh contactor QC/C_A, the eighth contactor QC/C_B, and the ninth contactor QC/C_C, and turns off the sixth contactor VS/C. As a result, a voltage of 400 V is supplied from the charging terminals 131P and 131N to the battery 2, and a voltage of 400 V is supplied via the branch circuit 14 to the coil 32U. By turning off the sixth contactor VS/C, the power supply from the battery 2 to the auxiliary device 4 is cut off.

Here, in order to drive the auxiliary device 4 having a base voltage of 800 V, it is necessary to boost a voltage of 400 V to an auxiliary device drive voltage which is a drive voltage of an accessory of the auxiliary device 4. The auxiliary device drive voltage may be 800 V or may not be 800 V.

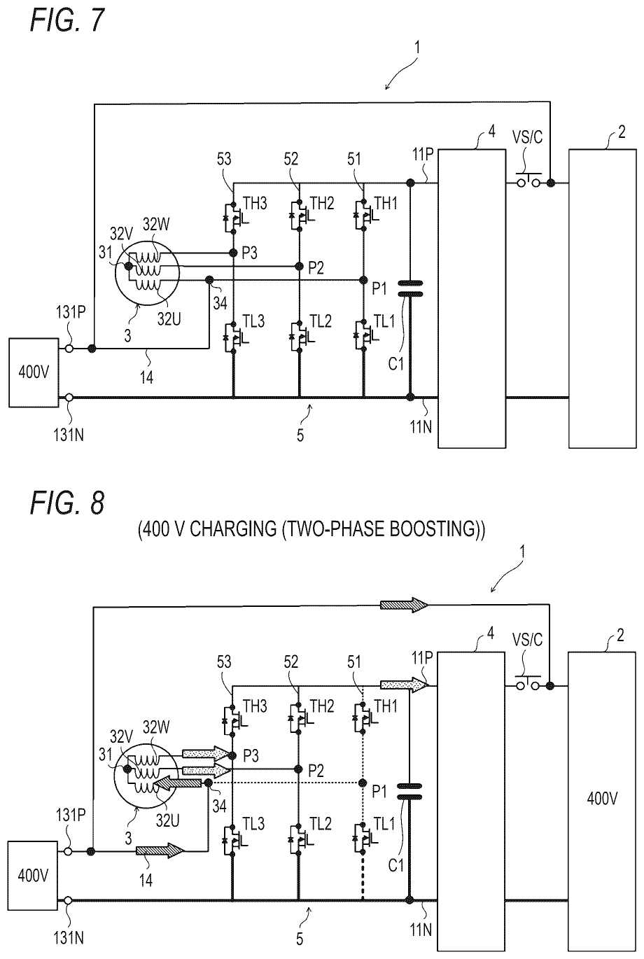

Next, a configuration of the inverter 5 and a boost operation performed by the three-phase motor 3 and the inverter 5 will be described with reference to FIGS. 7 to 9.

FIG. 7 is a schematic diagram showing a schematic configuration of the charging system 1 according to the first embodiment.

As shown in FIG. 7, the inverter 5 includes a first branch circuit 51 including a first high-side switch TH1, a first low-side switch TL1, and a first node P1 connecting the first high-side switch THI and the first low-side switch TL1 in series, a second branch circuit 52 including a second high-side switch TH2, a second low-side switch TL2, and a second node P2 connecting the second high-side switch TH2 and the second low-side switch TL2 in series, and a third branch circuit 53 including a third high-side switch TH3, a third low-side switch TL3, and a third node P3 connecting the third high-side switch TH3 and the third low-side switch TL3 in series. Each of the first branch circuit 51, the second branch circuit 52, and the third branch circuit 53 has a high-side switch side end connected in parallel with the electric power supply circuit 11P on the positive electrode side, and a low-side switch side end connected in parallel with the electric power supply circuit 11N on the negative electrode side.

The first node P1 is connected to the U-phase terminal 33U and thereby connected to the coil 32U, the second node P2 is connected to the V-phase terminal 33V and thereby connected to the coil 32V, and the third node P3 is connected to the W-phase terminal 33W and thereby connected to the coil 32W. Note that the switches TH1, TL1, TH2, TL2, TH3, and TL3 are implemented by, for example, MOSFETs, whose opening and closing control is performed by the control unit 10 by adjusting a gate voltage.

A diode operating as a reflux diode is connected in parallel with each of the switches TH1, TL1, TH2, TL2, TH3, and TL3. The reflux diodes are provided to prevent damage to the switching elements by causing a current flowing back from a motor 3 side to reflux (regenerate) to a battery 2 side when the switches TH1, TL1, TH2, TL2, TH3, and TL3 are turned off. That is, the inverter 5 allows a current to flow from the three-phase motor 3 side to the battery 2 side regardless of an ON or OFF state of a gate, and allows a current to flow from the battery 2 side to the three-phase motor 3 side only when the gate is in an ON state.

When charging is performed with the charging equipment of 400 V class, the control unit 10 controls the charging system 1 to a state shown in FIG. 6. As a result, a voltage of 400 V is supplied from the charging terminals 131P and 131N to the battery 2, and a voltage of 400 V is supplied via the branch circuit 14 to the coil 32U. The power supply from the battery 2 to the auxiliary device 4 is cut off, and thus it is necessary to boost the voltage of 400 V to the auxiliary device drive voltage of the auxiliary device 4 in order to drive the auxiliary device 4. In the following description, the boosted voltage corresponding to the auxiliary device drive voltage may be referred to as a secondary voltage.

FIG. 8 is a diagram showing a flow of a current at the time of two-phase boosting during charging at the second voltage (400 V) of the charging system 1 according to the first embodiment.

Therefore, in the state shown in FIG. 6, the control unit 10 performs high-frequency switching of the second low-side switch TL2 and the third low-side switch TL3 to perform a booster operation of switching between ON states of the second low-side switch TL2 and the third low-side switch TL3 and OFF states of the second low-side switch TL2 and the third low-side switch TL3. Note that the other switches TL1 and TH1 to TH3 of the inverter 5 are maintained in the OFF state.

Accordingly, the energy stored in the coils 32U, 32V, and 32W when the second low-side switch TL2 and the third low-side switch TL3 are in the ON state is released when the second low-side switch TL2 and the third low-side switch TL3 are in the OFF state, so that the voltage of 400 V provided from the charging terminals 131P and 131N is boosted to the secondary voltage and supplied from the inverter 5 to the auxiliary device 4. Hereinafter, such a booster operation state performed by the three-phase motor 3 and the inverter 5 is referred to as a two-phase booster mode.

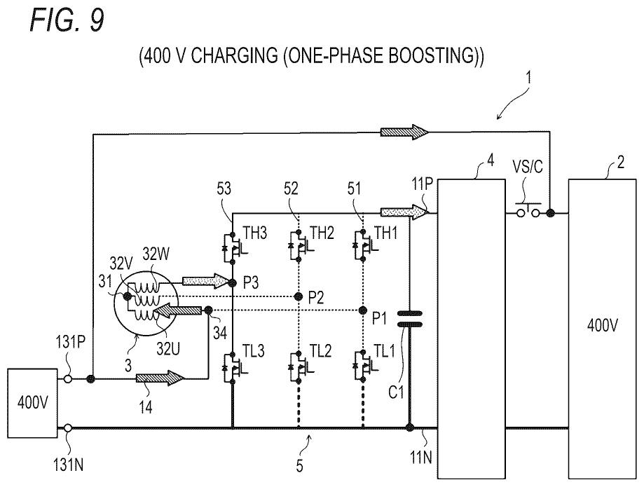

FIG. 9 is a diagram showing a flow of a current at the time of one-phase boosting during charging at the second voltage (400 V) of the charging system 1 according to the first embodiment.

In the state shown in FIG. 6, the control unit 10 performs high-frequency switching of the third low-side switch TL3 to perform a booster operation of switching between the ON state of the third low-side switch TL3 and the OFF state of the third low-side switch TL3. Note that the other switches TL1, TL2, and TH1 to TH3 of the inverter 5 are maintained in the OFF state.

Accordingly, the energy stored in the coils 32U and 32W when the third low-side switch TL3 is in the ON state is released when the third low-side switch TL3 is in the OFF state, so that the voltage of 400 V provided from the charging terminals 131P and 131N is boosted to the secondary voltage and supplied from the inverter 5 to the auxiliary device 4. Hereinafter, such a booster operation state performed by the three-phase motor 3 and the inverter 5 is referred to as a one-phase booster mode.

When the control unit 10 boosts the electric power supplied to the auxiliary device 4 in the above-described two-phase booster mode or one-phase booster mode during charging at the second voltage (400 V), the control unit 10 determines the secondary voltage based on operation required information of the auxiliary device 4, and selects the booster mode to be used for boosting based on the determined secondary voltage. That is, the control unit 10 includes a secondary voltage determination unit that determines the secondary voltage, and a phase number selection unit that selects the number of phases to be driven during boosting.

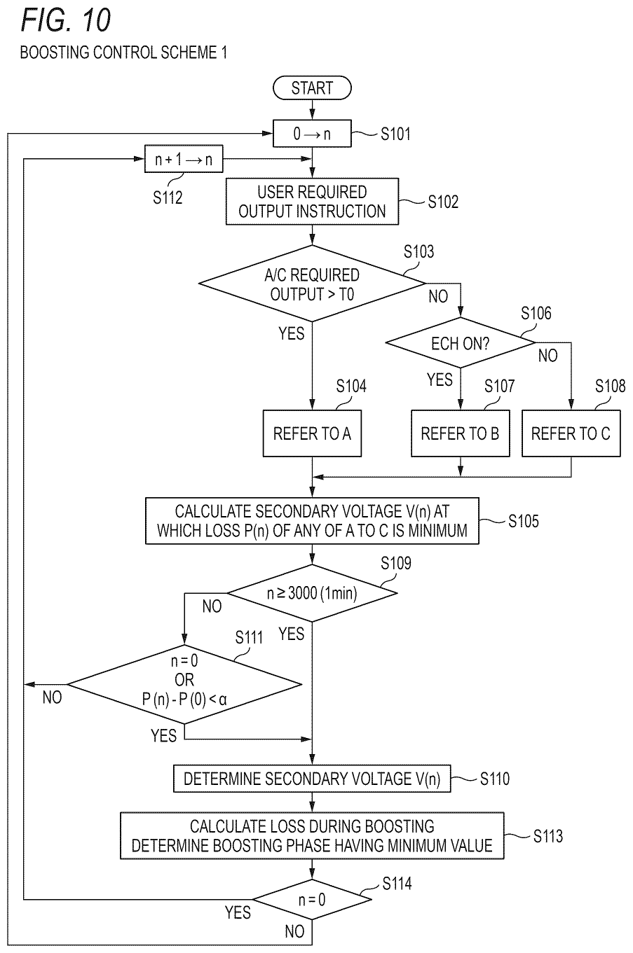

Next, three boosting control schemes 1 to 3 that can be applied during charging at the second voltage (400 V) will be described with reference to FIGS. 10 to 16.

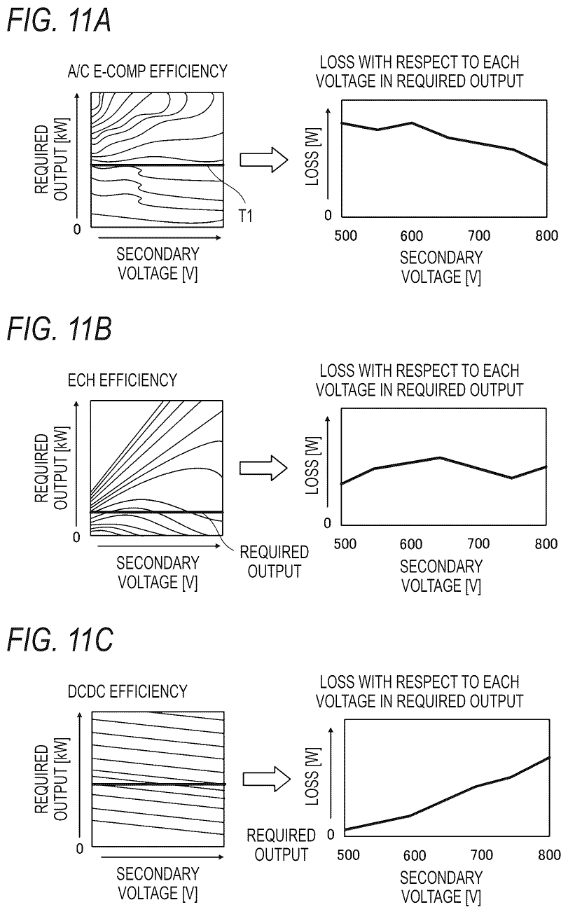

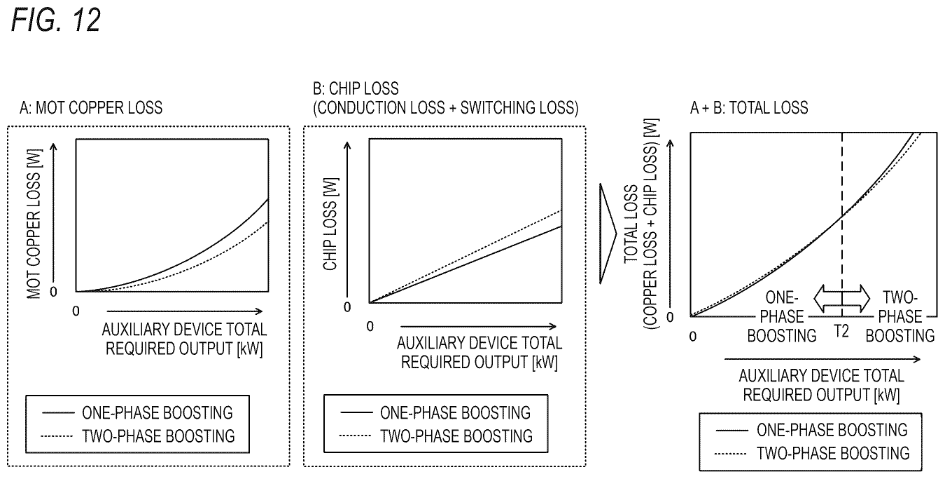

FIG. 10 is a flowchart showing the boosting control scheme 1 according to the first embodiment, FIGS. 11A to 11C are diagrams showing a method for determining the secondary voltage in the boosting control scheme 1, and FIG. 12 is a diagram showing a method for determining a boosting phase in the boosting control scheme 1.

In the boosting control scheme 1, the control unit 10 determines the secondary voltage such that a loss of the auxiliary device 4 with highest output among a plurality of the auxiliary devices 4 is minimum, and selects the booster mode in which a boosting loss in the determined secondary voltage is minimum. Accordingly, it is possible to supply electric power provided from a charging facility to the auxiliary device 4 with high efficiency during charging at the second voltage (400 V).

Specifically, as shown in FIG. 10, when charging at the second voltage (400 V), the control unit 10 sets a variable n to 0 (S101), and then samples a user required output for the auxiliary device 4 (S102). A sampling time for the user required output is, for example, about 20 msec. The electric vehicle of the present embodiment includes the electric compressor E-COMP, the electric heater ECH, and an auxiliary device converter DCDC as the auxiliary devices 4, and therefore samples these user required outputs. Although outputs of the auxiliary devices 4 differ depending on user requirements, when comparing a maximum output, the electric compressor E-COMP is the largest, followed by the electric heater ECH and the auxiliary device converter DCDC in this order. Therefore, when determining the secondary voltage such that the loss of the auxiliary device 4 with highest output among the plurality of auxiliary devices 4 is minimum, the loss of the electric compressor E-COMP is given the highest priority.

Specifically, as shown in FIG. 10, the control unit 10 samples the user required output for the auxiliary device 4 (S102), and then determines whether a required output of an air conditioner (electric compressor E-COMP) exceeds a predetermined air conditioner driving threshold TO (for example, 5 kW) (S103), and if the determination result is YES, the control unit 10 uses a calculation rule shown in FIG. 11A to calculate a secondary voltage V(n) in which a loss P(n) is minimum (S104, S105). If the determination result in step S103 is NO, the control unit 10 determines whether the electric heater ECH is ON (S106), and if the determination result is YES, the control unit 10 uses a calculation rule shown in FIG. 11B to calculate the secondary voltage V(n) in which the loss P(n) is minimum (S107, S105). If the determination result in step S106 is NO, the control unit 10 uses a calculation rule shown in FIG. 11C to calculate the secondary voltage V(n) in which the loss P(n) is minimum (S108, S105).

In each of the calculation rules shown in FIGS. 11A to 11C, correlation data showing a correlation between the secondary voltage corresponding to the sampled user required output and the loss is extracted (see graphs on a right side of FIGS. 11A to 11C) from an efficiency map showing the correlation between the user required output, the secondary voltage, and the loss in each of the auxiliary devices 4 (see graphs on a left side of FIGS. 11A to 11C), and the secondary voltage at which the loss is minimum in the extracted correlation data is calculated. For example, as shown in FIG. 11A, if the user required output of the sampled air conditioner (electric compressor E-COMP) is T1 kW (T1 kW>5 kW), the secondary voltage V(n) is set to 800 V at which the loss is minimum in a boosting allowable range (for example, 500 V to 800 V).

Returning to FIG. 10, the control unit 10 calculates the secondary voltage V(n) (S105), and then determines whether the variable n is equal to or larger than, for example, 3000 (accumulated calculation time is 1 min) (S109), and if the determination result is YES, the control unit 10 determines the secondary voltage V(n) based on the calculation result of step S105 (S110). If the determination result of step S109 is NO, the control unit 10 determines whether n=0 or loss P(n)−P(0)<α (α represents a negative threshold) is satisfied (S111), and if the determination result is YES, the control unit 10 determines the secondary voltage V(n) based on the calculation result of step S105 (S110), but if the determination result is NO, the control unit 10 increments the variable n (S112) and returns to step S102. The process of step S109 is for preventing frequent switching of control, and the process of step S111 is for allowing a change in the secondary voltage when the loss P(n) is lower than the threshold α compared to the initial loss P(0) even if a predetermined time does not elapse.

After determining the secondary voltage V(n) (S110), the control unit 10 calculates the loss during boosting in the determined secondary voltage V(n) and selects the booster mode in which the loss is minimum (S113). In the charging system 1 of the present embodiment, the coil 32U in the coils 32U, 32V, and 32W of three phases is connected to the branch circuit 14 at the connection portion 34 located between the U-phase terminal 33U and the inverter 5, and thus, the control unit 10 sets two phases (V phase, W phase) which are not connected to the charging terminal 131P as the maximum number of selectable phases to select the number of phases of the coils which can be used for boosting. The control unit 10 selects the one-phase booster mode when the number of phases to be selected is one phase, and selects the two-phase booster mode when the number of phases to be selected is two phases.

For example, as shown in FIG. 12, the booster mode is selected, the booster mode having a smaller total loss which is a sum of a copper loss of each of the booster modes with respect to a total required output of the auxiliary devices 4 at the determined secondary voltage V(n) and a chip loss (conduction loss+switching loss) of each of the booster modes with respect to the total required output of the auxiliary devices 4 at the determined secondary voltage V(n). In the example shown in FIG. 12, the one-phase booster mode and the two-phase booster mode are switched when the total required output of the auxiliary devices 4 is T2 kW. In other words, when the total required output of the auxiliary devices 4 is less than T2 kW, the one-phase booster mode is selected, and when the total required output of the auxiliary devices 4 is equal to or larger than T2 kW, the two-phase booster mode is selected.

Thereafter, the control unit 10 determines whether the variable n is 0 (S114), and if the determination result is YES, the control unit 10 increments the variable n (S112) and returns to step S102, and if the determination result is NO, the control unit 10 returns to step S101.

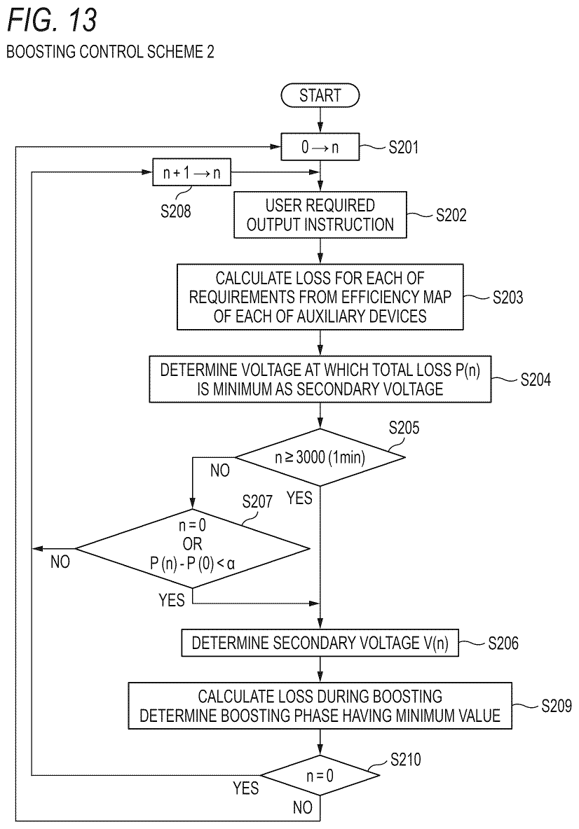

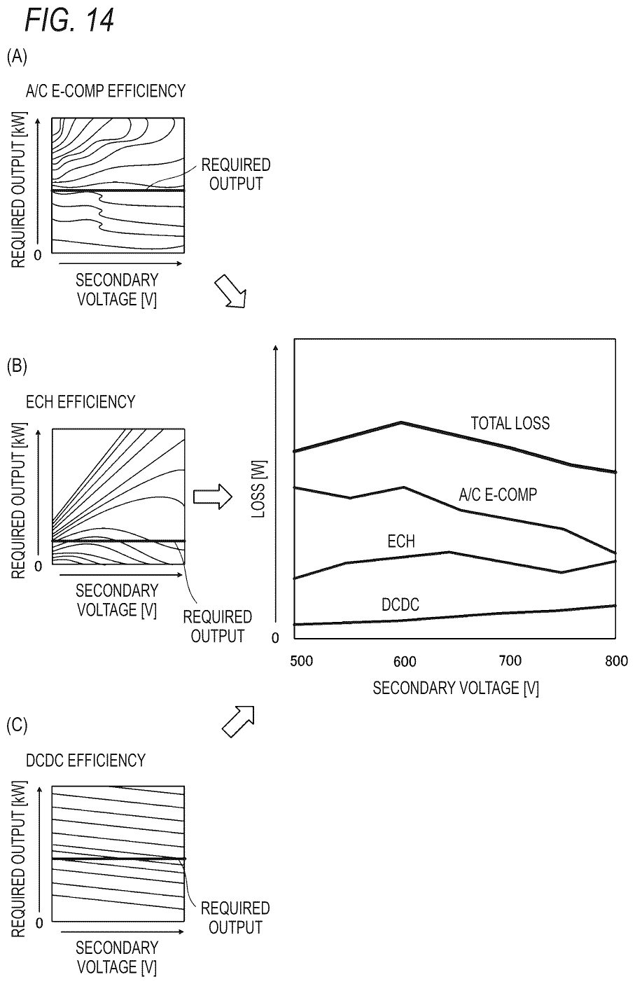

FIG. 13 is a flowchart showing the boosting control scheme 2 according to the first embodiment, and FIG. 14 is a diagram showing a method for determining the secondary voltage in the boosting control scheme 2.

In the boosting control scheme 2, the control unit 10 determines the secondary voltage such that a total loss of the plurality of auxiliary devices 4 is minimum, and selects the booster mode in which the boosting loss in the determined secondary voltage is minimum. Accordingly, it is possible to supply electric power provided from a charging facility to the auxiliary device 4 with high efficiency during charging at the second voltage (400 V).

Specifically, as shown in FIG. 13, when charging at the second voltage (400 V), the control unit 10 sets the variable n to 0 (S201), and then samples the user required output for the auxiliary device 4 (S202). The sampling time for the user required output is, for example, about 20 msec. The electric vehicle of the present embodiment includes the electric compressor E-COMP, the electric heater ECH, and the auxiliary device converter DCDC as the auxiliary devices 4, and therefore samples these user required outputs.

After sampling the user required output for the auxiliary device 4 (S202), the control unit 10 calculates the loss for the user required output for each of the auxiliary devices 4 based on the efficiency map of each of the auxiliary devices 4 shown on a left side of FIG. 14 (S203). Next, the control unit 10 calculates the secondary voltage V(n) at which the total loss P(n), which is a sum of the losses of the auxiliary devices 4, is minimized, as shown on a right side of FIG. 14 (S204). In the example of FIG. 14, the secondary voltage V(n) is set to 800 V in which the total loss P(n) is minimum.

The control unit 10 calculates the secondary voltage V(n) (S204), and then determines whether the variable n is equal to or larger than, for example, 3000 (accumulated calculation time is 1 min) (S205), and if the determination result is YES, the control unit 10 determines the secondary voltage V(n) based on the calculation result of step S204 (S206). If the determination result of step S205 is NO, the control unit 10 determines whether n=0 or loss P(n)−P(0)<α (α represents a negative threshold) is satisfied (S207), and if the determination result is YES, the control unit 10 determines the secondary voltage V(n) based on the calculation result of step S204 (S206), but if the determination result is NO, the control unit 10 increments the variable n (S208) and returns to step S202. The process of step S205 is for preventing frequent switching of control, and the process of step S207 is for allowing a change in the secondary voltage when the loss P(n) is lower than the threshold α compared to the initial loss P(0) even if a predetermined time does not elapse.

After determining the secondary voltage V(n) (S206), the control unit 10 calculates the loss during boosting at the determined secondary voltage V(n) and selects the booster mode in which the loss is minimum (S209). A specific method for selecting the booster mode is the same as that of the boosting control scheme 1 described in FIG. 12. Thereafter, the control unit 10 determines whether the variable n is 0 (S210), and if the determination result is YES, the control unit 10 increments the variable n (S208) and returns to step S202, and if the determination result is NO, the control unit 10 returns to step S201.

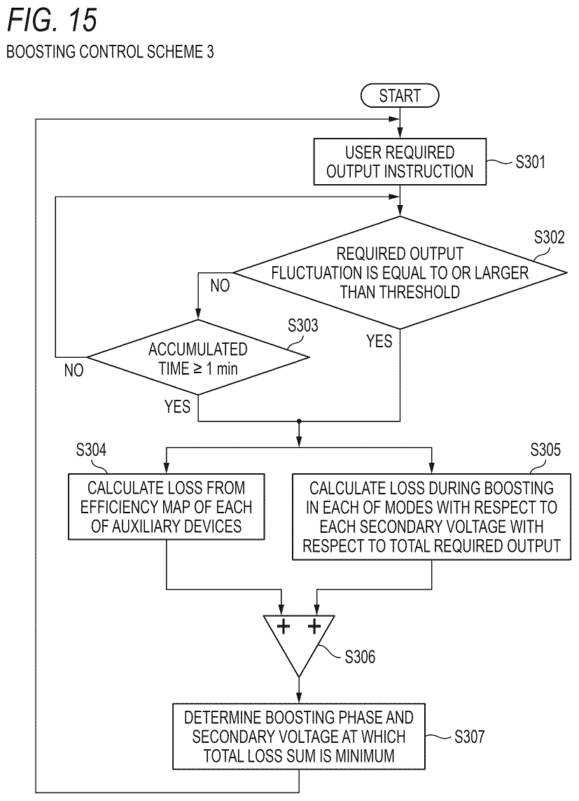

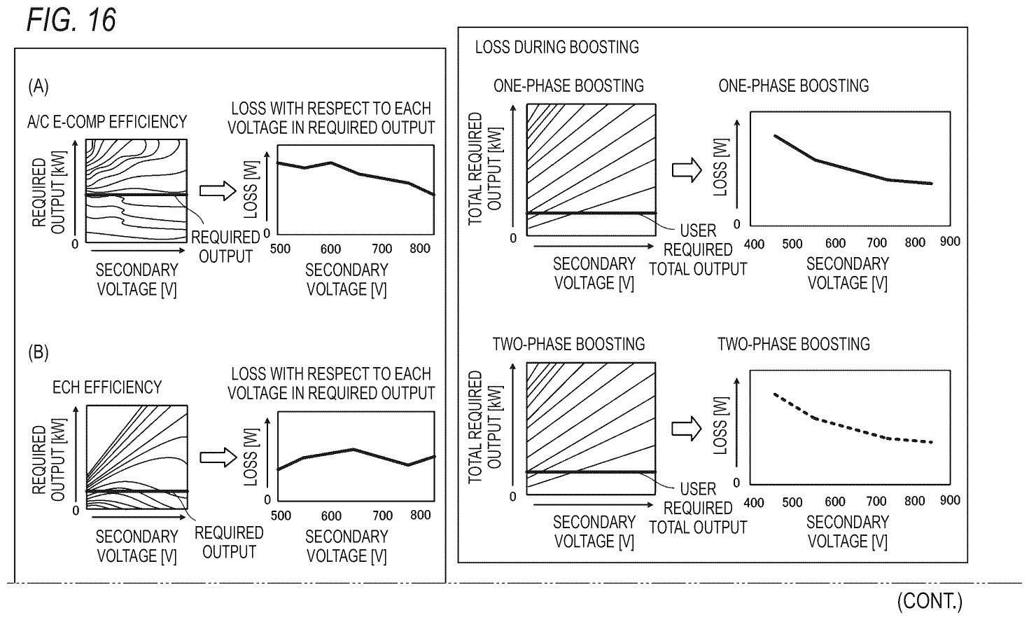

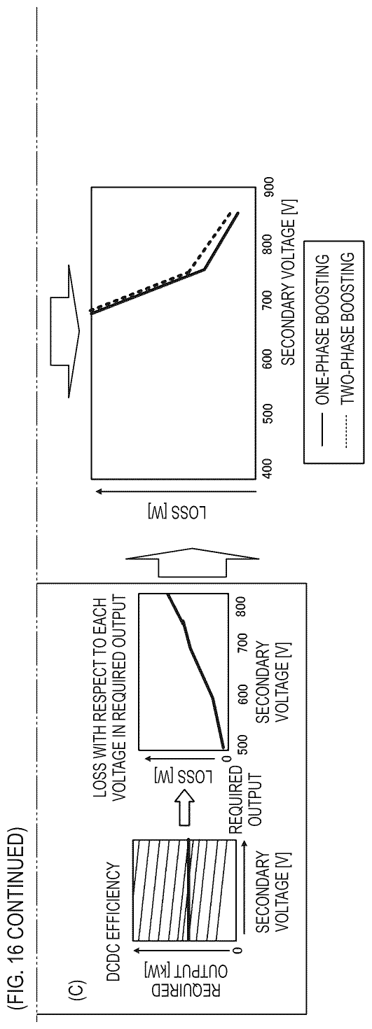

FIG. 15 is a flowchart showing the boosting control scheme 3 according to the first embodiment, and FIG. 16 is a diagram showing a method for determining the secondary voltage and a boosting phase of the boosting control scheme 3.

In the boosting control scheme 3, the control unit 10 selects the secondary voltage and the booster mode based on a loss with respect to each secondary voltage for the user required output of each of the auxiliary devices 4 and a loss with respect to each secondary voltage for each of the booster mode with respect to a total value of the user required outputs of the auxiliary devices 4. Accordingly, it is possible to supply electric power provided from a charging facility to the auxiliary device 4 with high efficiency during charging at the second voltage (400 V).

Specifically, as shown in FIG. 15, when charging at the second voltage (400 V), the control unit 10 samples the user required output for the auxiliary device 4 (S301). The sampling time for the user required output is, for example, 10 msec to 20 msec. The electric vehicle of the present embodiment includes the electric compressor E-COMP, the electric heater ECH, and the auxiliary device converter DCDC as the auxiliary devices 4, and therefore samples these user required outputs.

After sampling the user required output for the auxiliary device 4 (S301), the control unit 10 determines whether a user required output fluctuation is equal to or larger than a threshold (S302), and if the determination result is NO, the control unit 10 determines whether a sampling accumulated time is equal to or long than, for example, 1 min (S303). If either step S302 or S303 is YES, the control unit 10 proceeds to steps S304 and S305, but if the determination result in step S303 is NO, the control unit 10 returns to step S302. The processes of steps S302 and S303 are intended to prevent frequent switching of control.

The control unit 10 executes steps S304 and S305 in parallel. In step S304, the control unit 10 calculates the loss with respect to each secondary voltage for the user required output of each of the auxiliary devices 4 based on the efficiency map of each of the auxiliary devices 4 shown on a left side of FIG. 16, and in step S305, the control unit 10 calculates the loss with respect to each secondary voltage for each of the booster modes with respect to the total value of the user required outputs of the auxiliary devices 4 based on the efficiency maps of the booster modes shown in the upper right of FIG. 16. After calculating a sum of the losses calculated in steps S304 and S305 (S306), the control unit 10 determines the booster mode and the secondary voltage at which the sum of the losses is minimum (S307), as shown in the lower right of FIG. 16, and returns to step S301.

### Second Embodiment

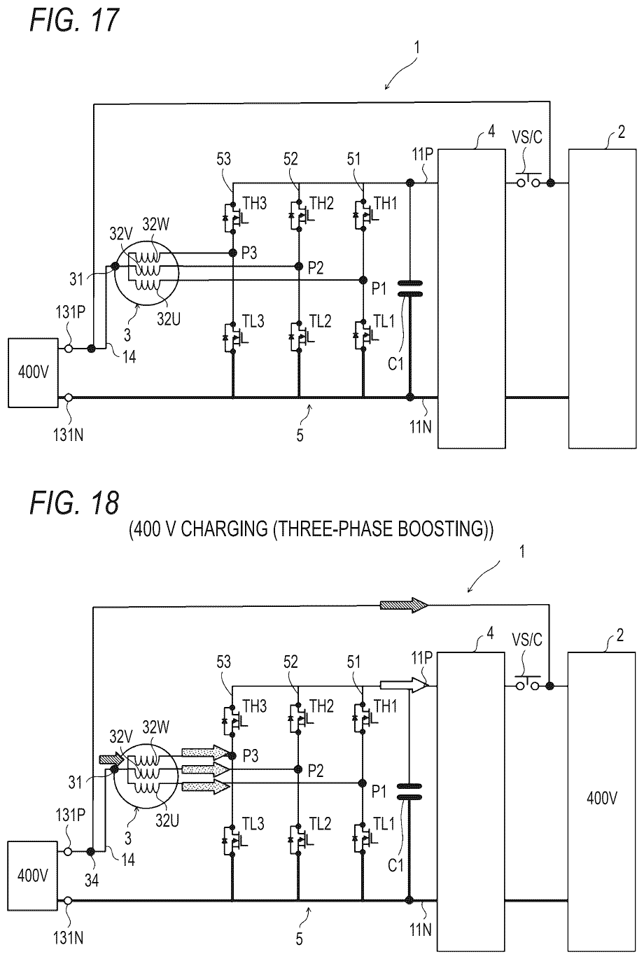

Next, the charging system 1 according to a second embodiment will be described with reference to FIGS. 17 to 21. Here, the same reference numerals as in the first embodiment are used for the same configurations as in the first embodiment, and the description of the first embodiment may be incorporated.

FIG. 17 is a schematic diagram showing a schematic configuration of the charging system 1 according to the second embodiment.

As shown in FIG. 17, the charging system 1 according to the second embodiment differs from that of the first embodiment in that the charging terminal 131P is connected to the neutral point 31 of the three-phase motor 3. Therefore, when charging at the second voltage (400 V) in the charging system 1 according to the second embodiment, the state is the same as that of FIG. 6, except that the charging terminal 131P is connected to the neutral point 31 of the three-phase motor 3. Since the charging system 1 according to the second embodiment has the charging terminal 131P connected to the neutral point 31 of the three-phase motor 3, the control unit 10 sets three phases (U phase, V phase, W phase) as the maximum number of selectable phases to select the number of phases of the coils that can be used for boosting. The control unit 10 selects the one-phase booster mode when the number of phases to be selected is one phase, selects the two-phase booster mode when the number of phases to be selected is two phases, and selects the three-phase booster mode when the number of phases to be selected is three phases.

FIG. 18 is a diagram showing a flow of a current at the time of three-phase boosting during charging at the second voltage (400 V) of the charging system 1 according to the second embodiment.

In the state shown in FIG. 6, the control unit 10 performs high-frequency switching of the first low-side switch TL1, the second low-side switch TL2, and the third low-side switch TL3 to perform a booster operation of switching between ON states of the first low-side switch TL1, the second low-side switch TL2, and the third low-side switch TL3 and OFF states of the first low-side switch TL1, the second low-side switch TL2, and the third low-side switch TL3. Note that the other switches TH1 to TH3 of the inverter 5 are maintained in the OFF state.

Accordingly, the energy stored in the coils 32U, 32V, and 32W when the first low-side switch TL1, the second low-side switch TL2, and the third low-side switch TL3 are in the ON state is released when the first low-side switch TL1, the second low-side switch TL2, and the third low-side switch TL3 are in the OFF state, so that the voltage of 400 V provided from the charging terminals 131P and 131N is boosted to the secondary voltage and supplied from the inverter 5 to the auxiliary device 4. Hereinafter, such a booster operation state performed by the three-phase motor 3 and the inverter 5 is referred to as a three-phase booster mode.

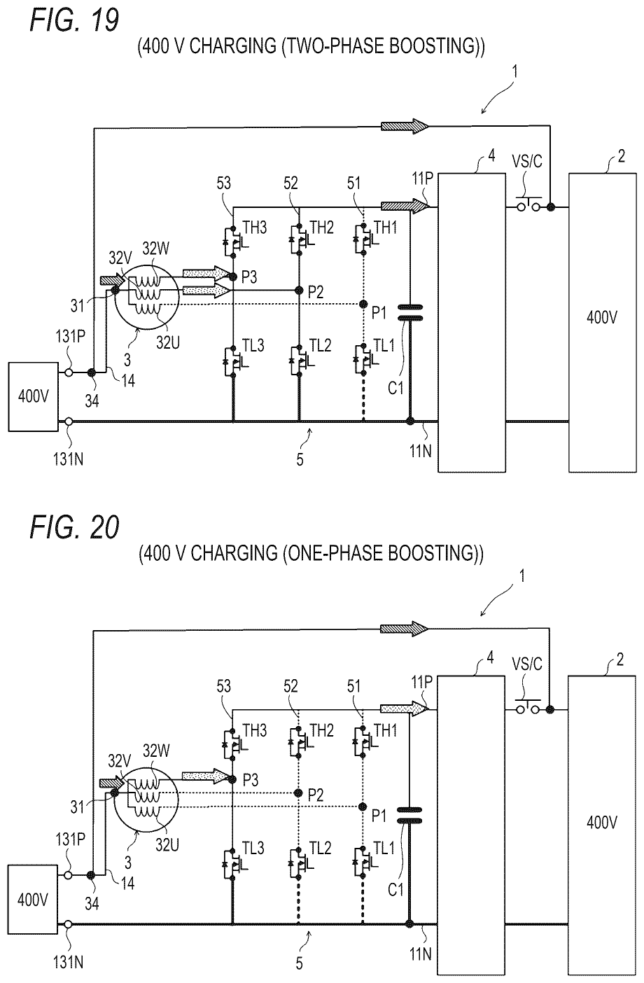

FIG. 19 is a diagram showing a flow of a current at the time of two-phase boosting during charging at the second voltage (400 V) of the charging system 1 according to the second embodiment.

In the state shown in FIG. 6, the control unit 10 performs high-frequency switching of the second low-side switch TL2 and the third low-side switch TL3 to perform a booster operation of switching between ON states of the second low-side switch TL2 and the third low-side switch TL3 and OFF states of the second low-side switch TL2 and the third low-side switch TL3. Note that the other switches TL1 and TH1 to TH3 of the inverter 5 are maintained in the OFF state.

Accordingly, the energy stored in the coils 32V and 32W when the second low-side switch TL2 and the third low-side switch TL3 are in the ON state is released when the second low-side switch TL2 and the third low-side switch TL3 are in the OFF state, so that the voltage of 400 V provided from the charging terminals 131P and 131N is boosted to the secondary voltage and supplied from the inverter 5 to the auxiliary device 4. Hereinafter, such a booster operation state performed by the three-phase motor 3 and the inverter 5 is referred to as the two-phase booster mode. Note that in this example, the V phase and the W phase are selected as the phases to be selected, but the U phase and the V phase, or the U phase and the W phase may be selected as the phases to be selected.

FIG. 20 is a diagram showing a flow of a current at the time of one-phase boosting during charging at the second voltage (400 V) of the charging system 1 according to the second embodiment.

In the state shown in FIG. 6, the control unit 10 performs high-frequency switching of the third low-side switch TL3 to perform a booster operation of switching between the ON state of the third low-side switch TL3 and the OFF state of the third low-side switch TL3. Note that the other switches TL1, TL2, and TH1 to TH3 of the inverter 5 are maintained in the OFF state.

Accordingly, the energy stored in the coil 32W when the third low-side switch TL3 is in the ON state is released when the third low-side switch TL3 is in the OFF state, so that the voltage of 400 V provided from the charging terminals 131P and 131N is boosted to the secondary voltage and supplied from the inverter 5 to the auxiliary device 4. Hereinafter, such a booster operation state performed by the three-phase motor 3 and the inverter 5 is referred to as the one-phase booster mode. Note that in this example, the W phase is selected as the phase to be selected, but the U phase or the V phase may be selected as the phase to be selected.

When the control unit 10 boosts the electric power supplied to the auxiliary device 4 in any one of the above-described three-phase booster mode, two-phase booster mode, and one-phase booster mode during charging at the second voltage (400 V), the control unit 10 determines the secondary voltage based on the operation required information of the auxiliary device 4, and selects the booster mode to be used for boosting based on the determined secondary voltage. In this case, the control unit 10 selects the booster mode in which the boosting loss at the determined secondary voltage is minimum.

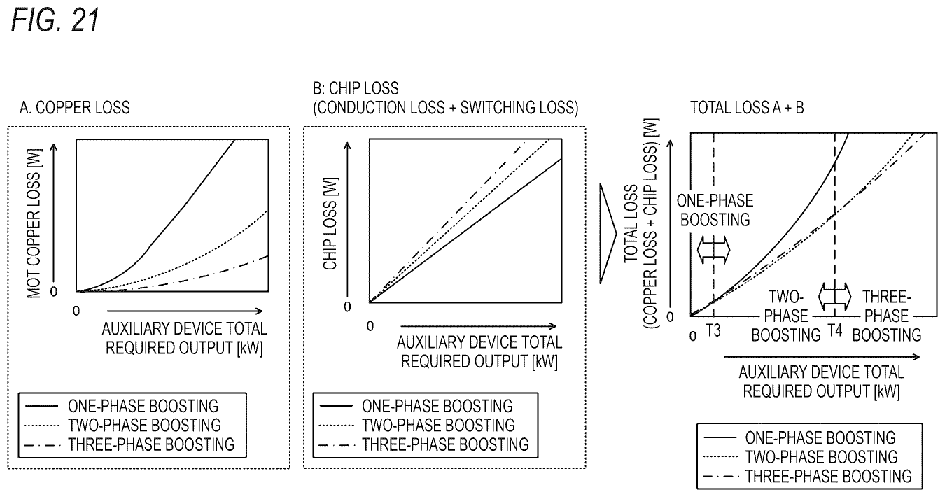

Specifically, as in the charging system 1 according to the first embodiment, any one of the three boosting control schemes 1 to 3 can be adopted. However, in the method for determining the boosting phase of the boosting control schemes 1 and 2 in the first embodiment, the map comparing the total losses of the one-phase booster mode and the two-phase booster mode shown in FIG. 12 is exemplified, but in the method for determining the boosting phase of the boosting control schemes 1 and 2 in the second embodiment, the map comparing the total losses of the one-phase booster mode, the two-phase booster mode, and the three-phase booster mode shown in FIG. 21 can be used.

For example, as shown in FIG. 21, the booster mode is selected, the booster mode having a smaller total loss which is a sum of a copper loss of each of the booster modes with respect to a total required output of the auxiliary devices 4 at the determined secondary voltage and a chip loss (conduction loss +switching loss) of each of the booster modes with respect to the total required output of the auxiliary devices 4 at the determined secondary voltage. In the example shown in FIG. 21, the one-phase booster mode and the two-phase booster mode are switched when the total required output of the auxiliary device 4 is T3 kW, and the two-phase booster mode and the three-phase booster mode are switched when the total required output of the auxiliary device 4 is T4 kW. In other words, when the total required output of the auxiliary device 4 is less than T3 kW, the one-phase booster mode is selected, when the total required output of the auxiliary device 4 is equal to or larger than T3 kW and less than T4 kW, the two-phase booster mode is selected, and when the total required output of the auxiliary device 4 is equal to or larger than T4 kW, the three-phase booster mode is selected.

Although the various embodiments have been described above with reference to the drawings, it is needless to say that the present invention is not limited to these examples. It is apparent that those skilled in the art can conceive of various modifications and changes within the scope described in the claims, and it is understood that such modifications and changes naturally fall within the technical scope of the present invention. In addition, respective constituent elements in the above-described embodiment may be freely combined without departing from the gist of the invention.

In the present specification, at least the following matters are described. Although corresponding constituent elements or the like in the embodiment described above are shown in parentheses, the present invention is not limited thereto.

(1) A charging system (charging system 1) of a vehicle, the charging system including:
a battery (battery 2);
an auxiliary device (auxiliary device 4) configured to be driven by electric power supplied from the battery when the battery supplies the electric power, in which the power supply from the battery to the auxiliary device is cut off when the battery is charged;
a DC voltage conversion unit (three-phase motor 3, inverter 5) configured to convert a DC voltage at a charging equipment side to an auxiliary device side voltage (auxiliary device drive voltage, secondary voltage) different from a battery voltage, and supply the auxiliary device side voltage to the auxiliary device; and
a control unit (control unit 10) configured to control the DC voltage conversion unit,
in which the DC voltage conversion unit includes coils (coils 32U, 32V, 32W) of a plurality of phases, and conversion units (switches TH1 to TH3, TL1 to TL3) provided for every phases of the plurality of phases,
the control unit includes a phase number selection unit configured to select a number of phases to be driven among the plurality of phases, and
the phase number selection unit is configured to:
   determine the auxiliary device side voltage based on operation required information of the auxiliary device,
   determine the number of phases to be driven based on the auxiliary device side voltage; and
   drive the determined number of phases to supply electric power to the auxiliary device.

According to (1), when the battery voltage and the auxiliary device side voltage are different, by setting the number of phases to be energized among the coils of the plurality of phases constituting the DC voltage conversion unit according to the operation required information of the auxiliary device, electric power can be supplied to the auxiliary device with high efficiency during charging.

(2) The charging system according to (1),
in which a plurality of the auxiliary devices are provided, and
the phase number selection unit determines the auxiliary device side voltage such that a loss of the auxiliary device with highest output among the plurality of auxiliary devices is minimum.

According to (2), the auxiliary device side voltage is determined such that the loss of the high-output auxiliary device having a great influence is minimum, and thus, a control can be simplified.

(3) The charging system according to (1),
in which the phase number selection unit selects an optimal number of phases based on the auxiliary device side voltage and electric power required for the auxiliary device.

According to (3), an appropriate number of phases can be selected in consideration of a copper loss of the coils and a switching loss of the conversion unit.

(4) The charging system according to (1),
a plurality of the auxiliary devices are provided, and
the phase number selection unit determines the auxiliary device side voltage such that a total loss of the plurality of auxiliary devices is minimum.

According to (4), the auxiliary device side voltage is determined such that the losses of the plurality of auxiliary devices are minimum, and thus, an appropriate auxiliary device side voltage can be determined.

(5) The charging system according to (1), further including:
a motor (three-phase motor 3) including the coils (coils 32U, 32V, 32W) of the plurality of phases driven by electric power supplied from the battery; and
an inverter (inverter 5) including the conversion units provided for every phases of the plurality of phases, and configured to convert DC electric power of the battery to AC electric power of the plurality of phases,
in which the DC voltage conversion unit includes the coils of the plurality of phases of the motor and the inverter.

According to (5), the DC voltage conversion unit can be implemented by the coils wound around the motor and the conversion units of the inverter, and thus, a dedicated voltage converter is unnecessary. Accordingly, miniaturization and cost reduction are possible.

(6) The charging system according to any one of (1) to (5), further including:
a three-phase motor (three-phase motor 3) including coils (coils 32U, 32V, 32W) of three phases driven by electric power supplied from the battery,
in which a charging terminal (charging terminal 131P) is connected to the coil of one phase of the three-phase motor, and
the phase number selection unit sets two phases which are not connected to the charging terminal as a maximum number of selectable phases to select a number of phases to be driven.

According to (6), voltage conversion can be performed in the more efficient mode of the one-phase booster mode and the two-phase booster mode.

(7) The charging system according to any one of (1) to (5), further including:
a three-phase motor (three-phase motor 3) including coils (coils 32U, 32V, 32W) of three phases driven by electric power supplied from the battery,
in which a charging terminal (charging terminal 131P) is connected to a neutral point (neutral point 31) of the three-phase motor, and
the phase number selection unit sets the three phases as a maximum number of selectable phases to select a number of phases to be driven.

According to (7), voltage conversion can be performed in the most efficient mode of the one-phase booster mode, the two-phase booster mode, and the three-phase booster mode.

(8) A charging system including:
a battery (battery 2);
a three-phase motor (three-phase motor 3) including coils (coils 32U, 32V, 32W) of three phases driven by electric power supplied from the battery;
an inverter (inverter 5) including conversion units (switches TH1 to TH3, TL1 to TL3) for every phases of the three phases, and configured to convert DC electric power of the battery to AC electric power of the three phases;
an auxiliary device (auxiliary device 4) configured to be driven by electric power supplied from the battery when the battery supplies the electric power, in which the power supply from the battery to the auxiliary device is cut off when the battery is charged;
a DC voltage conversion unit including the coils of the three phases of the three-phase motor, and the conversion units provided for every phases of the three phases of the inverter; and
a control unit (control unit 10) configured to control charging of the battery,
in which a charging terminal (charging terminal 131P) is connected between the coil of any one phase of the coils of the three phases of the three-phase motor and the conversion unit of the one phase of the inverter, and
when charging the battery, based on operation required information of the auxiliary device, the control unit selects a two-phase booster mode and a one-phase booster mode to supply electric power to the auxiliary device, in which
   in the two-phase booster mode, other two phases of the coils of the three phases of the three-phase motor are driven to boost a charging voltage, and
   in the one-phase booster mode, one of the other two phases of the coils of the three phases of the three-phase motor is driven to boost the charging voltage.

According to (8), when a battery voltage and an auxiliary device side voltage are different, by setting the number of phases among the coils of the three-phase motor constituting the DC voltage conversion unit according to operation required information of the auxiliary device, voltage conversion can be performed in the more efficient mode of the one-phase booster mode and the two-phase booster mode, and the electric power can be supplied to the auxiliary device with high efficiency during charging. In addition, the DC voltage conversion unit can be implemented by the coils wound around the motor and the conversion units of the inverter, and thus, a dedicated voltage converter is unnecessary. Accordingly, miniaturization and cost reduction are possible.

(9) A charging system including:
a battery (battery 2);
a three-phase motor (three-phase motor 3) including coils (coils 32U, 32V, 32W) of three phases driven by electric power supplied from the battery;
an inverter (inverter 5) including conversion units (switches TH1 to TH3, TL1 to TL3) for every phases of the three phases, and configured to convert DC electric power of the battery to AC electric power of the three phases;
an auxiliary device (auxiliary device 4) configured to be driven by electric power supplied from the battery when the battery supplies the electric power, in which the power supply from the battery to the auxiliary device is cut off when the battery is charged;
a DC voltage conversion unit including the coils of the three phases of the three-phase motor, and the conversion units provided for every phases of the three phases of the inverter; and
a control unit (control unit 10) configured to control charging of the battery,
in which a charging terminal (charging terminal 131P) is connected to a neutral point (neutral point 31) of the coils of the three phases of the three-phase motor, and
when charging the battery, based on operation required information of the auxiliary device, the control unit selects a three-phase booster mode, a two-phase booster mode, and a one-phase booster mode to supply electric power to the auxiliary device, in which
   in the three-phase booster mode, the coils of the three phases of the three-phase motor are driven to boost a charging voltage
   in the two-phase booster mode, any two phases of the coils of the three phases of the three-phase motor are driven to boost the charging voltage, and
   in the one-phase booster mode, any one phase of the coils of the three phases of the three-phase motor is driven to boost the charging voltage.

According to (9), when a battery voltage and an auxiliary device side voltage are different, by setting the number of phases among the coils of the three-phase motor constituting the DC voltage conversion unit according to the operation required information of the auxiliary device, voltage conversion can be performed in the most efficient mode of the one-phase booster mode, the two-phase booster mode, and the three-phase booster mode, and the electric power can be supplied to the auxiliary device with high efficiency during charging. In addition, the DC voltage conversion unit can be implemented by the coils wound around the motor and the conversion units of the inverter, and thus, a dedicated voltage converter is unnecessary. Accordingly, miniaturization and cost reduction are possible.

What is claimed is:

1. A charging system of a vehicle, the charging system comprising:
a battery;
an auxiliary device configured to be driven by electric power supplied from the battery when the battery supplies the electric power, in which the power supply from the battery to the auxiliary device is cut off when the battery is charged;
a DC voltage conversion unit configured to convert a DC voltage at a charging equipment side to an auxiliary device side voltage different from a battery voltage, and supply the auxiliary device side voltage to the auxiliary device; and
a control unit configured to control the DC voltage conversion unit,
wherein the DC voltage conversion unit includes coils of a plurality of phases, and conversion units provided for every phases of the plurality of phases,
the control unit includes a phase number selection unit configured to select a number of phases to be driven among the plurality of phases, and
the phase number selection unit is configured to:
determine the auxiliary device side voltage based on operation required information of the auxiliary device,
determine the number of phases to be driven based on the auxiliary device side voltage; and
drive the determined number of phases to supply electric power to the auxiliary device.

2. The charging system according to claim 1,
wherein a plurality of the auxiliary devices are provided, and
the phase number selection unit determines the auxiliary device side voltage such that a loss of the auxiliary device with highest output among the plurality of auxiliary devices is minimum.

3. The charging system according to claim 1,
wherein the phase number selection unit selects an optimal number of phases based on the auxiliary device side voltage and electric power required for the auxiliary device.

4. The charging system according to claim 1,
wherein a plurality of the auxiliary devices are provided, and
the phase number selection unit determines the auxiliary device side voltage such that a total loss of the plurality of auxiliary devices is minimum.

5. The charging system according to claim 1, further comprising:
a motor including the coils of the plurality of phases driven by electric power supplied from the battery; and
an inverter including the conversion units provided for every phases of the plurality of phases, and configured to convert DC electric power of the battery to AC electric power of the plurality of phases,
wherein the DC voltage conversion unit includes the coils of the plurality of phases of the motor and the inverter.

6. The charging system according to claim 1, further comprising:
a three-phase motor including coils of three phases driven by electric power supplied from the battery,
wherein a charging terminal is connected to the coil of one phase of the three-phase motor, and
the phase number selection unit sets two phases which are not connected to the charging terminal as a maximum number of selectable phases to select a number of phases to be driven.

7. The charging system according to claim 1, further comprising:
a three-phase motor including coils of three phases driven by electric power supplied from the battery,
wherein a charging terminal is connected to a neutral point of the three-phase motor, and
the phase number selection unit sets the three phases as a maximum number of selectable phases to select a number of phases to be driven.

8. A charging system comprising:
a battery;
a three-phase motor including coils of three phases driven by electric power supplied from the battery;
an inverter including conversion units for every phases of the three phases, and configured to convert DC electric power of the battery to AC electric power of the three phases;
an auxiliary device configured to be driven by electric power supplied from the battery when the battery supplies the electric power, in which the power supply from the battery to the auxiliary device is cut off when the battery is charged;
a DC voltage conversion unit including the coils of the three phases of the three-phase motor, and the conversion units provided for every phases of the three phases of the inverter; and
a control unit configured to control charging of the battery,
wherein a charging terminal is connected between the coil of any one phase of the coils of the three phases of the three-phase motor and the conversion unit of the one phase of the inverter, and
when charging the battery, based on operation required information of the auxiliary device, the control unit selects a two-phase booster mode and a one-phase booster mode to supply electric power to the auxiliary device, in which
in the two-phase booster mode, other two phases of the coils of the three phases of the three-phase motor are driven to boost a charging voltage, and
in the one-phase booster mode, one of the other two phases of the coils of the three phases of the three-phase motor is driven to boost the charging voltage.

9. A charging system comprising:
a battery;
a three-phase motor including coils of three phases driven by electric power supplied from the battery;
an inverter including conversion units for every phases of the three phases, and configured to convert DC electric power of the battery to AC electric power of the three phases;
an auxiliary device configured to be driven by electric power supplied from the battery when the battery supplies the electric power, in which the power supply from the battery to the auxiliary device is cut off when the battery is charged;
a DC voltage conversion unit including the coils of the three phases of the three-phase motor, and the conversion units provided for every phases of the three phases of the inverter; and
a control unit configured to control charging of the battery,
wherein a charging terminal is connected to a neutral point of the coils of the three phases of the three-phase motor, and
when charging the battery, based on operation required information of the auxiliary device, the control unit selects a three-phase booster mode, a two-phase booster mode, and a one-phase booster mode to supply electric power to the auxiliary device, in which
in the three-phase booster mode, the coils of the three phases of the three-phase motor are driven to boost a charging voltage,
in the two-phase booster mode, any two phases of the coils of the three phases of the three-phase motor are driven to boost the charging voltage, and
in the one-phase booster mode, any one phase of the coils of the three phases of the three-phase motor is driven to boost the charging voltage.
